(19) United States
(12) Patent Application Publication
(10) Pub. No.: US 2026/0228077 A1
(43) Pub. Date: Aug. 6, 2026

(54) PROACTIVE MICROSERVICE ERROR DETECTION

(71) Applicant: Capital One Services, LLC, McLean, VA (US)

(72) Inventors: Hong GUO, Glen Allen, VA (US); Tony GEORGE, Clarksburg, MD (US); Ayushi CHAUHAN, Brunswick, NJ (US); Dhanveer SINGH, Glen Allen, VA (US); Kshitiz SINGH, Arlington, VA (US)

(21) Appl. No.: 19/044,976

(22) Filed: Feb. 4, 2025

(51) Int. Cl. G06F 11/07

(52) U.S. Cl. CPC G06F 11/079; G06F 11/0709

(57) ABSTRACT

In some implementations, a test system may cause, for a microservice system that includes multiple microservices, one or more test workflows to be performed. The test system may obtain, based on the one or more test workflows, result information indicating results of the one or more test workflows, wherein the result information indicates error information for an error associated with at least one test workflow of the one or more test workflows. The test system may determine a microservice, of the multiple microservices, that is a cause of the error based on a comparison of an identifier of the error to one or more known identifiers of respective known errors, wherein the identifier of the error is based on the error information. The test system may provide report information for display, wherein the report information indicates the error and that the microservice is the cause of the error.

### BACKGROUND

A microservice architecture may include a software application that includes a suite of independently deployable and modular applications that each execute a unique process and interact to achieve an overall functionality of the software application. The microservice architecture provides a framework to develop, deploy, and/or maintain microservices independently. Microservices allow a large application to be separated into smaller independent parts, with each part having an independent function or responsibility. Each microservice may be a single service configured to perform an application feature and/or to perform one or more discrete tasks. To serve a single user request, a microservices-based application can call on multiple internal microservices to compose a response.

### SUMMARY

Some implementations described herein relate to a test system for microservice error detection. The test system may include one or more memories and one or more processors communicatively coupled to the one or more memories. The one or more processors may be configured to cause, for a microservice system that includes multiple microservices, one or more test workflows to be performed, wherein the one or more test workflows are configured to test one or more functions of the microservice system. The one or more processors may be configured to obtain, based on the one or more test workflows, result information indicating results of the one or more test workflows. The one or more processors may be configured to detect, based on the result information, an error associated with at least one test workflow of the one or more test workflows. The one or more processors may be configured to determine a cause of the error based on a comparison of the error to one or more known errors. The one or more processors may be configured to provide, for display, report information that indicates the error and the cause.

Some implementations described herein relate to a method for microservice error detection. The method may include causing, by a test system and for a microservice system that includes multiple microservices, one or more test workflows to be performed. The method may include obtaining, by the test system and based on the one or more test workflows, result information indicating results of the one or more test workflows, wherein the result information indicates error information for an error associated with at least one test workflow of the one or more test workflows. The method may include determining, by the test system, a microservice, of the multiple microservices, that is a cause of the error based on a comparison of an identifier of the error to one or more known identifiers of respective known errors, wherein the identifier of the error is based on the error information. The method may include providing, by the test system, report information for display, wherein the report information indicates the error and that the microservice is the cause of the error.

Some implementations described herein relate to a non-transitory computer-readable medium that stores a set of instructions. The set of instructions, when executed by one or more processors of a test system, may cause the test system to cause, for a microservice system that includes multiple microservices, one or more test workflows to be performed. The set of instructions, when executed by one or more processors of the test system, may cause the test system to obtain, based on the one or more test workflows, result information indicating results of the one or more test workflows, wherein the result information indicates error information for an error associated with at least one test workflow of the one or more test workflows. The set of instructions, when executed by one or more processors of the test system, may cause the test system to determine a microservice, of the multiple microservices, that is a cause of the error based on a comparison of an identifier of the error to one or more known identifiers of respective known errors, wherein the identifier of the error is based on the error information. The set of instructions, when executed by one or more processors of the test system, may cause the test system to provide report information for display, wherein the report information indicates the error and that the microservice is the cause of the error.

### BRIEF DESCRIPTION OF THE DRAWINGS

FIGS. 1A-1D are diagrams of an example associated with microservice error detection, in accordance with some embodiments of the present disclosure.

FIGS. 2A and 2B are diagrams of an example associated with a user interface for microservice error detection, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with microservice error detection, in accordance with some embodiments of the present disclosure.

FIG. 5 is a flowchart of an example process associated with microservice error detection, in accordance with some embodiments of the present disclosure.

### DETAILED DESCRIPTION

The following detailed description of example implementations refers to the accompanying drawings. The same reference numbers in different drawings may identify the same or similar elements.

Microservice architecture is an application design framework that structures an application as a collection of loosely-coupled, independently-deployable services (referred to herein as “microservices”). Each microservice may be configured to perform on a specific function and communicate with other microservices over lightweight protocols, such as hypertext transfer protocol (HTTP) or message queues, such as by using application programming interfaces (APIs). The microservice architecture enables flexibility, scalability, and/or maintainability by allowing different microservices to be developed, deployed, and/or scaled independently. Microservices may be implemented using containers and orchestrated using cloud platforms or container orchestration tools, enabling rapid deployment and fault tolerance. Additionally, a given microservice may be reused across multiple applications or systems, improving efficiency and/or reducing redundancy across applications and systems (e.g., a microservice may have reusable functionality implemented in different applications). A microservice system may include a set of microservices that each perform a particular functionality of the microservices system. The microservices may interact with each other to perform an overall functionality of the microservices system. For example, a function of a microservice system may be performed via one or more microservices.

Testing in a microservice system may introduce additional complexities due to the independent and/or modular configuration of microservices. Because the microservices communicate with each other via APIs or other interfaces and perform discrete tasks, testing can be performed to verify that the microservices integrate correctly and perform as expected when combined as part of the full microservice system. Testing may include integration testing, end-to-end testing, and/or other types of testing. Integration testing may ensure that the different microservices within the microservice system interact as intended. Integration testing may be designed to verify that the interfaces between microservices are functioning properly, and that data passed between microservices is accurate and correctly handled. Given that microservices may rely on external resources, such as databases, third-party APIs, and/or other services, integration testing may ensure that such dependencies are managed appropriately, reducing the likelihood of data mismatches or failures in communication. End-to-end testing is a comprehensive test that validates the workflow of the microservices system from one end to the other, thereby simulating real-world usage. In an end-to-end test, the microservice system may be tested as a whole, ensuring that all microservices work together correctly and produce an intended result.

Because microservices are independently developed and deployed, there is a risk of incompatibility or failure when different microservices interact. Without thorough testing, it may become difficult to detect issues that may not appear in isolated unit tests, such as errors in service communication, timing issues, and/or cascading failures across multiple services, among other examples. Additionally, because microservices often evolve independently (e.g., microservices may be independently updated, upgraded, and/or maintained), a robust testing suite is needed to ensure that new features or updates in one microservice do not introduce errors for the functionality of other parts of the microservice system.

However, before a test system can perform a test, all microservices involved in the test must be functioning and/or available. Because microservices can be independently maintained, deployment and maintenance schedules between microservices can vary. Therefore, it is difficult to ensure that each microservice involved in the test is functioning and/or available before performing a test. This may result in the test indicating an error due to a microservice being offline, such as for maintenance (e.g., where the error is not actually indicative of a problem with the microservice). Additionally, when errors occur during a test, the microservice system may output one or more error messages. In some examples, the error message may include high-level information indicating that there was an error for a given function or workflow of the microservice system. However, detailed information for the error may be obfuscated in the error message due to the complexity of the multiple microservices involved in performing the given function or workflow. To address the error, a cause of the error (e.g., microservice(s) that caused the error) may be needed in order to perform one or more corrective actions to mitigate the error and/or to reduce the likelihood of the error occurring again. As a result, further analysis of the microservice system may be performed to determine the cause (e.g., a root cause) of the error (e.g., to determine which microservice(s) caused the error). This consumes processing resources, network resources, and/or time associated with performing the further analysis. Further, because the error messages may include high-level information for detected errors, it may be difficult for a test system to track and/or evaluate incidents and/or outages for the microservice system over time (e.g., to track which microservice(s) were associated with incidents and/or outages for the microservice system over time).

Some implementations described herein enable microservice error and/or outage detection. In some implementations, a test system may cause, for a microservice system that includes multiple microservices, one or more test workflows to be performed. A test workflow may be configured to test one or more functions of the microservice system. “Workflow” refers to one or more tasks, steps, and/or processes that are performed (e.g., in a series, a sequence, and/or in parallel) to achieve a particular goal or function. A test workflow may involve coordination between multiple microservices of the microservice system, with each microservice performing one or more tasks to perform a function for which the test workflow is configured to test. The test system may periodically perform the one or more test workflows. The test system may obtain, based on the performance of the one or more test workflows, result information that indicates results of the one or more test workflows. The test system may detect or determine, based on the result information, an error associated with a test workflow of the one or more test workflows. For example, the result information may include error information (e.g., one or more error messages) for the test workflow.

The test system may determine a cause of the error based on a comparison of the error to one or more known errors. For example, the test system may access a library (e.g., a database) of known errors. The comparison may indicate similarity levels between the error and respective known errors. If a similarity level satisfies a similarity threshold, then the test system may determine that the error is similar to the known error. For example, error information for similar errors may vary slightly, such as in identifiers, dates, a time stamp, error codes, and/or other information. Therefore, using the similarity levels enables the test system to identify matching and/or similar errors that may not have exactly the same error information. In some implementations, the test system may determine the similarity levels using a matching operation, such as a substring matching operation and/or a fuzzy matching operation, among other examples. For example, the test system may generate an identifier of the error information, such as a sequence or a hash of the error information (e.g., of an error object defining the error information). The test system may compare the identifier to identifiers (e.g., sequences and/or hashes) of respective known errors to determine the similarity levels.

The test system may determine the cause of the error based on a known cause of the known error (e.g., that is determined as matching or being similar to the error). For example, the cause may be one or more microservices included in the microservice system. In some implementations, the test system may detect multiple errors for a test workflow during a time window. For example, the test system may detect an outage for the test workflow based on a quantity of the multiple errors satisfying an outage threshold.

In some implementations, the test system may transmit, to one or more subscriber accounts, notification information. The notification information may indicate one or more detected errors, one or more detected outages, and/or the result information for the one or more test workflows, among other examples. In some implementations, the test system may provide, for display, report information that indicates the detected error(s) and respective causes of the detected error(s).

As a result, the test system can identify an error for a microservice system and determine the cause (e.g., one or more microservices) of the error. For example, by the test system using the similarity level between a detected error and a known error, the test system can match a known cause to the detected error in scenarios where error information varies for the same type of error. This reduces the complexity associated with determining the cause of the detected error, thereby conserving processing resources, network resources, and/or time that would have otherwise been associated with analyzing the error information and/or the microservice system to determine the cause of the error. Additionally, by the test system determining and/or detecting errors (e.g., incidents) as described herein, the test system can determine and/or detect outages for the microservice system and/or for particular microservices.

By the test system transmitting the notification information, a team or system that manages a particular microservice may quickly identify an error and/or outage associated with the microservice, enabling the team to take corrective action(s) and mitigate negative effects caused by the error and/or outage. Further, by the test system providing the report information for display, trends and/or patterns in errors and/or outages can be easily tracked and/or maintained in a single report and/or user interface. This improves access to error and/or outage information for the microservice system, thereby enabling one or more teams or systems to quickly identify errors and/or outages associated with the microservice system and/or reduce downtime for the microservice system.

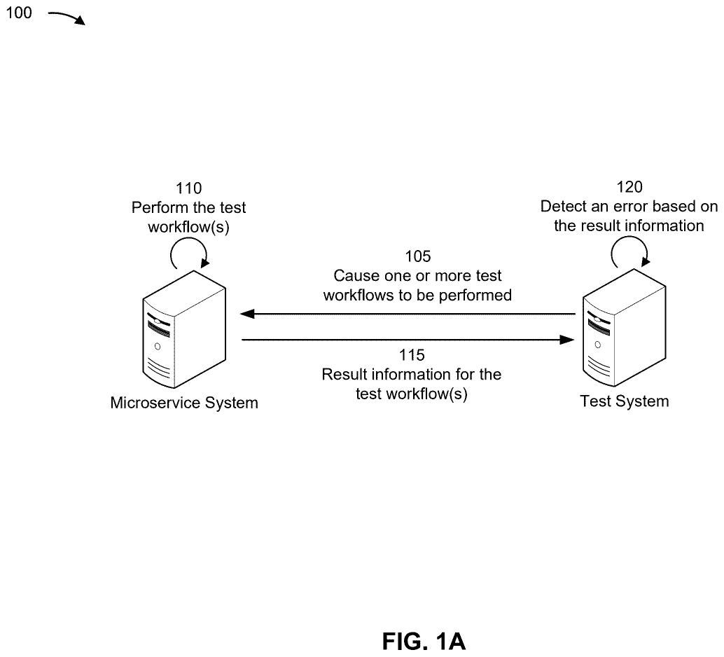

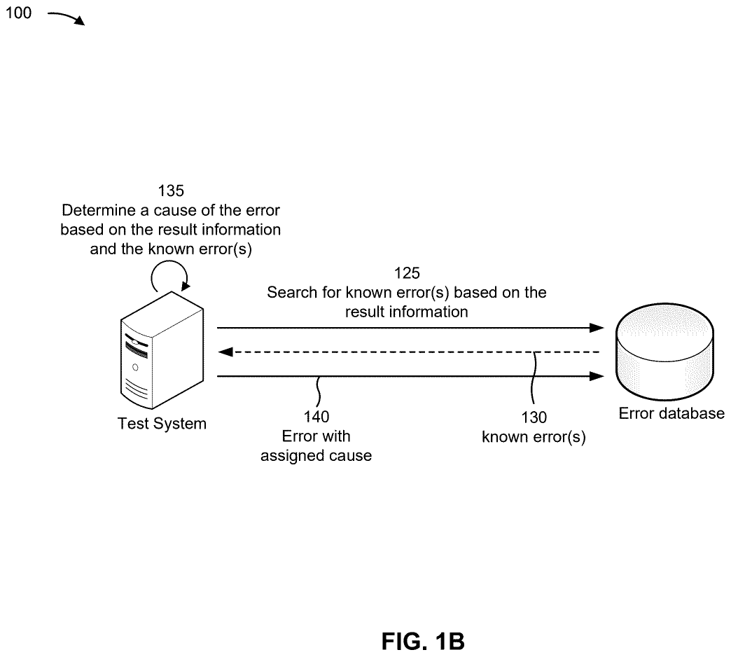

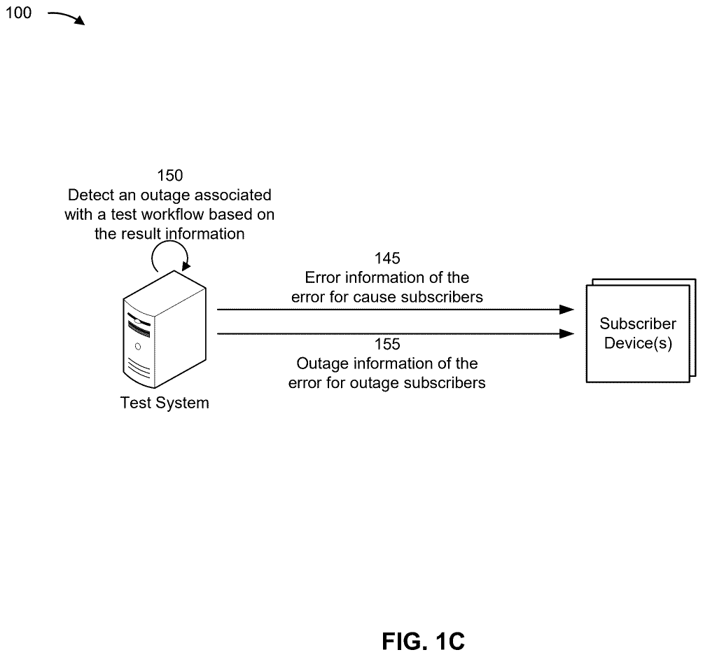

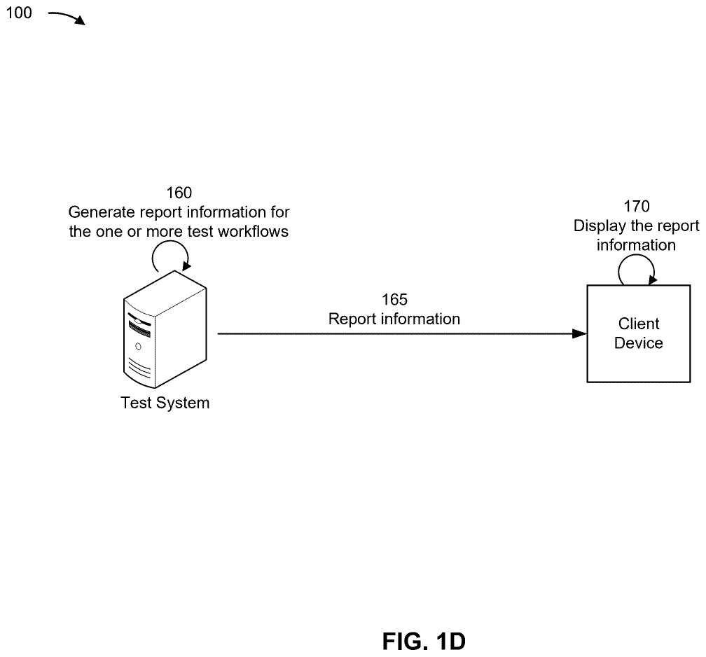

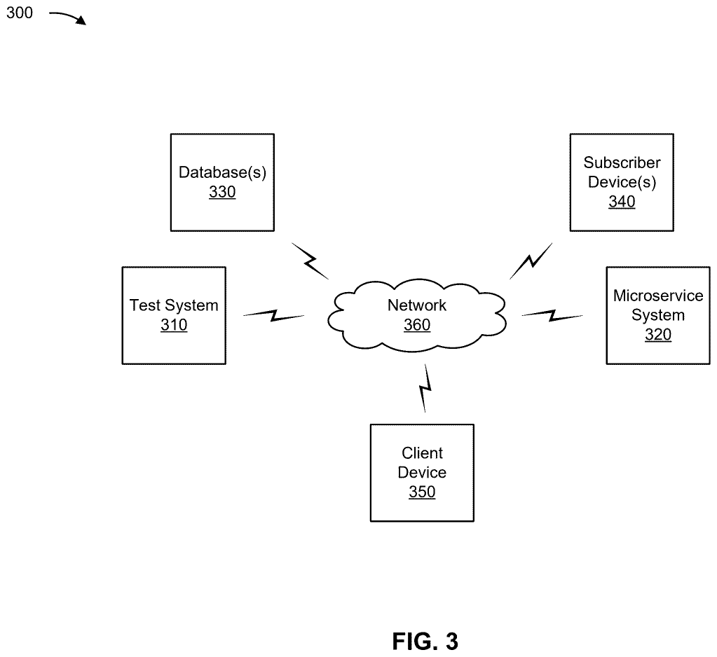

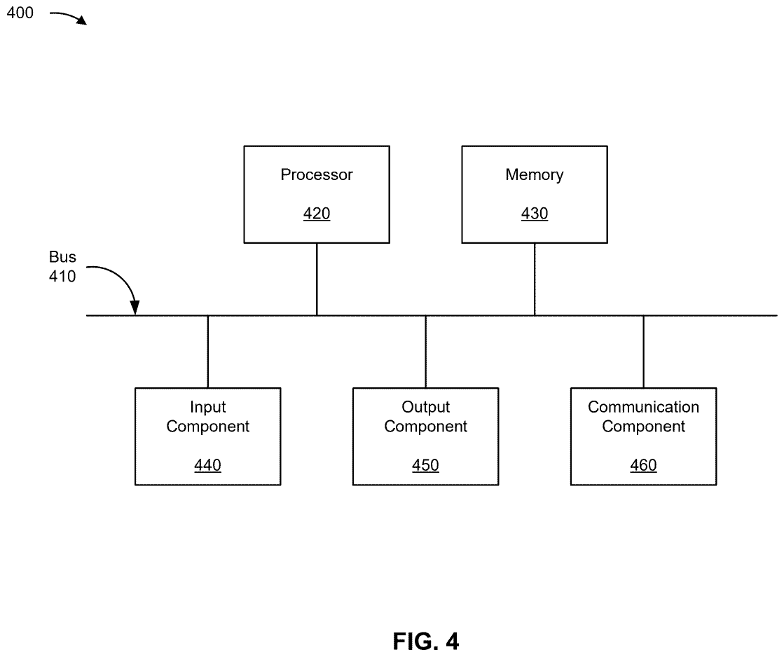

FIGS. 1A-1D are diagrams of an example 100 associated with microservice error detection. As shown in FIGS. 1A-1D, example 100 includes a test system, a microservice system, one or more databases, one or more subscriber devices, and/or a client device. These devices are described in more detail in connection with FIGS. 3 and 4.

The microservice system may include multiple microservices. As used herein, “microservice” refers to an independent component or service configured to perform one or more tasks, functions, and/or operations, among other examples for the microservice system. For example, the multiple microservices may be independently deployable, configurable, and/or manageable. For example, different teams may manage respective microservices of the multiple microservices.

A microservice may be an application with dedicated functionality. The multiple microservices may communicate over a network (such as via one or more APIs) to perform workflows for the microservice system. A microservice may be deployed using different technologies, such as a server, an application service, a cloud computing system, a container, a serverless component (e.g., a serverless function), and/or a virtual machine, among other examples.

As shown in FIG. 1A, and by reference number 105, the test system may cause one or more test workflows to be performed by the microservice system. For example, the test system may obtain configuration information that indicates the one or more test workflows. A test workflow may be configured or designed to test one or more functions of the microservice system. For example, a test workflow may be configured or designed to mimic end-user operation of the microservice system for the one or more functions.

The test system may cause the test workflow(s) to be performed in a synchronous mode or an asynchronous mode. For example, the synchronous mode may include the test system transmitting, and the microservice system receiving, a request (such as an HTTP request) for the microservice system to perform the test workflow (and/or to perform the one or more functions being tested by the test workflow). The asynchronous mode may be performed for event-driven test workflows. For example, an event-driven test workflow may be performed by the microservice system based on, or in response to, an event. In such examples, the test system may cause an event-driven test workflow to be performed by the microservice system by performing the event or causing the event to occur.

In some implementations, the test system may be configured to perform the one or more test workflows periodically. For example, a configuration for a test workflow may indicate a periodic schedule defining when the test workflow is to be performed. For example, the configuration may indicate one or more time-based triggers for performing the test workflow. The test system may cause the test workflow to be performed based on the periodic schedule (e.g., based on a time-based trigger being met, such as a timer expiring, or a current time being a time at which the test workflow is to be performed, as indicated by the periodic schedule). In some implementations, the periodic schedule may indicate one or more times at which the test workflow is to be performed. The one or more times may be equally spaced in time (e.g., such as the test workflow being performed one every N hours). In some other implementations, the one or more times may not be equally spaced in time (e.g., the periodic schedule may indicate the times at which the test workflow is to be performed). In some implementations, the test system may perform a test workflow aperiodically, such as based on receiving a user input indicating that the test workflow is to be performed and/or based on detecting a test event (such as a deployment of a new microservice and/or function for the microservice system).

By the test system causing the one or more test workflows to be performed based on a schedule (e.g., the periodic schedule), the likelihood that microservices that are configured to perform action(s) for the function(s) being tested by the test workflow are available and/or are online may be improved. For example, by the test system using the schedule, the test system may coordinate maintenance schedules to avoid the test workflow being performed at a time during which a microservice is scheduled to be offline. This improves the performance of the testing performed by the test system, as described in more detail elsewhere herein.

As shown by reference number 110, the microservice system may perform the one or more test workflows. For example, one or more microservices may perform one or more tasks, operations, and/or services, among other examples, for a function being tested by the test workflow. In some implementations, two or more microservices may communicate with each other to perform the function being tested by the test workflow.

The microservice system may generate result information for the one or more test workflows. The result information may indicate a result and/or a status of the one or more test workflows. For example, the result information may indicate whether the one or more test workflows were successfully performed.

In some implementations, if the result information indicates that a test workflow was not successfully performed, then the result information may include error information for one or more errors that caused the test workflow to not be successfully performed. The error information for a given error may be included in an error message. The error information for a given error may include an error code (e.g., a code identifying a type of error), an error description (e.g., a human-readable description of the error, such as “user not found” or “payment processing failed”), a time stamp (e.g., a time and date indicating when the error occurred), stack trace information (e.g., information about the error in a software stack, such as function calls or lines of code associated with the error), and/or context information (e.g., information about the request that triggered the error, such as a request identifier, input parameter(s), user identifier(s), workflow identifier(s), or other information), among other examples.

As shown by reference number 115, the microservice system may transmit, and the test system may receive, the result information for the one or more test workflows. For example, the microservice system (and/or another system) may provide the result information to an API endpoint associated with the test system. The test system may analyze the result information. For example, the test system may process the result information to determine the result and/or status of the one or more test workflows.

In some implementations, the test system may transmit, and one or more subscriber devices may receive, the result information. For example, the test system may store subscriber information indicating one or more accounts for which result information is to be provided for one or more test workflows. For example, an account can subscribe to receive result information for a given test workflow. The test system may store (e.g., in a database) the subscriber information. The test system may determine, for each test workflow performed, if there are any subscriber accounts that are subscribed to receive the result information for that test workflow. The subscriber information may indicate an address (e.g., a phone number, an email address, a messaging service address, or another type of address) to which the result information is to be transmitted. For example, the test system transmitting the result information to an address may cause the result information to be transmitted to a subscriber device (e.g., which is used to access the account associated with the address).

As shown by reference number 120, the test system may detect an error based on the result information. For example, as described above, the result information may include error information for one or more errors. The test system may detect the error based on the result information including the error information (e.g., based on the result information including an error message). The test system may generate an incident based on detecting an error. For example, an incident may be indicative of one or more errors having occurred for a given test workflow.

The test system may generate an error object based on the error information for a given error. An error object may be a data object or a data structure that includes the error information for a given error. For example, the error object may have a format (e.g., indicating fields for respective types of error information, such as an error code field, an error identifier field, a timestamp field, a user field, and/or other fields). By the test system generating the error object, the test system can organize error information for detected errors in a consistent manner. This facilitates the test system identifying similar errors, as described in more detail elsewhere herein.

As shown in FIG. 1B, the test system may determine a cause of the error based on the result information (e.g., the error information included in the result information) and one or more known errors. For example, the test system may determine the cause (e.g., a root cause) based on detecting the error and/or generating an incident for the error.

For example, as shown by reference number 125, the test system may search for one or more known errors based on the result information. For example, as described above, the test system may generate an error object based on the error information included in the result information. The test system may generate an identifier based on the error object. The error identifier may be a sequence and/or other information that is indicative of the error object (e.g., that is unique to the error object). For example, the identifier may be a hash of the error object. In such examples, the test system may generate the identifier (e.g., the hash) by inputting the error object into a hash function, such as a secure hash algorithm, a message digest algorithm, a cyclic redundancy check function, a hash-based message authentication code, and/or another type of hash function. For example, the hash function may be configured to output a value or code (e.g., having a fixed size) based on the error object input to the hash function.

The test system may search for known errors using the identifier (e.g., using the hash or the sequence of the error object). For example, as shown in FIG. 1B, the one or more databases may include an error database that stores error information (e.g., error objects) for respective known errors. A “known” error refers to an error for which the error database includes error information. For example, a known error may be an error previously detected by the test system and/or an error for which a user has input error information to be stored in the error database.

As shown by reference number 130, the test system may identify one or more known errors based on the error (e.g., detected by the test system as described in connection with reference number 120). For example, the test system may query the error database using the identifier of the error. If the error database returns a known error based on the query (e.g., if a known error is stored in the error database with the same identifier), then the error may have occurred previously. In such examples, the known error can be used to determine the cause (e.g., the root cause) of the detected error, as explained in more detail elsewhere herein.

If the query does not result in a match (e.g., if no known errors are stored in the error database with the identifier of the error), then the test system may compare the error to one or more known errors to identify known errors that are similar to the detected error. For example, the test system may compare the error to one or more known errors. The comparison may be between the identifier of the error (e.g., the sequence or hash of the error object) and one or more identifiers of respective known errors. For example, based on the query not returning an exact match to the identifier of the error, the test system may obtain one or more identifiers (e.g., known identifiers) of respective known errors from the error database. The test system may use the identifier of the error and the obtained identifiers to determine whether any known errors are similar to the detected error.

In some implementations, the error database may include one or more known identifiers for respective causes (e.g., for respective root causes). For example, a given cause (e.g., a given root cause) may be associated with one or more known identifiers. The one or more known identifiers may be similar to the identifier of the detected error. For example, a known identifier may be a string (e.g., a unique sequence and/or a hash) indicative of an error that was caused by a given cause (e.g., a given root cause). The test system may obtain, from the error database, one or more known identifiers that have known causes (such as from a root cause table in the error database).

In some implementations, the test system may match the error to a known error based on the comparison. An error may be “matched” to a known error based on the test system determining that a similarity level between the error and the known error satisfies a threshold. For example, the test system may determine one or more similarity levels between the error and respective known errors based on the comparison. For example, the test system may determine one or more similarity levels between the identifier of the error and the one or more known identifiers of respective known errors.

In some implementations, the test system may perform a matching operation to determine the similarity levels. For example, the matching operation may compare a sequence of the identifier to sequences of respective known identifiers obtained by the test system. The matching operation may include a substring matching operation, a fuzzy matching operation, and/or another type of matching operation. The result of the matching operation (e.g., the similarity level) may be indicative of how similar two identifiers are (e.g., the identifier of the detected error and a known identifier of a known error). For example, the test system may perform a substring matching operation to determine whether one or more substrings from the identifier (e.g., a substring from the string of the identifier) are included in the known identifier. If the test system determines that the one or more substrings are included in the known identifier, then the test system may determine that the detected error matches the known error. If the test system determines that the one or more substrings are not included in the known identifier, then the test system may determine that the detected error does not match the known error. In such examples, the similarity level may indicate whether the error matches the known error (e.g., a similarity level of 1 may indicate a match, whereas a similarity level of 0 may indicate no match).

As another example, the test system may perform a fuzzy matching operation to determine the similarity levels. In such examples, the similarity levels may be an edit distance score (e.g., a number of edit operations needed to transform the identifier into the known identifier), a Jaro-Winkler distance, a cosine similarity, a Jaccard similarity, and/or an N-gram similarity, among other examples.

In some implementations, the test system may determine that a similarity level satisfies a threshold. For example, the test system may determine that the similarity level indicates that the detected error matches a known error (e.g., based on a substring matching operation using one or more known identifiers). Additionally, or alternatively, the test system may determine that the similarity level indicates that the detected error and a known error are different, but approximately the same. For example, by the test system using the identifier and the known identifier(s) to perform the comparison, the test system may be enabled to determine a known error that is similar to the detected error, where there are some differences between the known error and the detected error (e.g., because the identifier and the known identifier(s) may be generated using error information for respective errors, as described in more detail elsewhere herein). This may reduce the complexity associated with the test system determining the cause of the detected error because similar errors may have the same cause (e.g., the same root cause).

For example, as shown by reference number 135, the test system may determine a cause of the error based on the result information (e.g., the error information) and the known error(s). For example, the comparison described above may indicate that a similarity level between the error and a known error satisfies a similarity threshold (e.g., the comparison may indicate that the error and the known error match and/or are similar). In some implementations, the test system may determine the cause of the error (e.g., the detected error) based on a known cause of the known error. For example, the known error may have a known cause of a microservice of the multiple microservices of the microservice system (e.g., as indicated by information stored for the known error in the error database). In such examples, the test system may determine that the cause of the error is the microservice based on the known cause being the microservice. For example, the test system may determine the cause of the detected error based on the known cause of the known error that is determined to match and/or be similar to the detected error.

In some other implementations, the test system may determine that the cause of the error is an unassigned cause. “Unassigned cause” may refer to an unknown cause (e.g., the test system may be unable to determine which microservice(s) caused the error). For example, the test system may determine that no similarity levels satisfy the similarity threshold (e.g., indicating that there are no known errors that are similar to the detected error). Additionally, or alternatively, the test system may determine that no known errors match the detected errors. Additionally, or alternatively, the test system may determine that a similarity level between the error and a known error satisfies a similarity threshold (e.g., the comparison may indicate that the error and the known error match and/or are similar), but that the known error has a known cause that is the unassigned cause (e.g., the known error may have an unknown cause). In such examples, the test system may determine that the cause of the error is the unassigned cause.

As shown by reference number 140, the test system may store error information for the detected error with an assigned cause in the error database. The assigned cause may be one or more microservices (e.g., as indicated by the known cause of the known error that is matched to and/or similar to the detected error) or may be the unassigned cause. By the test system storing the error information for the detected error with the assigned cause, the test system may improve cause determinations for errors of the microservice system detected in the future (e.g., because the test system may be able to use the error information and/or the identifier of the error as part of the cause determinations described herein, thereby improving the likelihood of the test system determining a matching and/or similar known error).

As shown in FIG. 1C, and by reference number 145, the test system may transmit, to one or more subscriber devices, the error information for the error based on determining the cause (e.g., in a cause message for the detected error). For example, as described above, the cause may be a microservice of the multiple microservices included in the microservice system. One or more accounts (e.g., cause subscriber accounts) may subscribe to receive notifications of errors caused by the microservice. In such examples, the test system may transmit the error information (e.g., in a cause message) for the error to addresses (e.g., to one or more subscriber devices and/or accounts) based on the error being caused by the microservice. This enables one or more users and/or systems to quickly identify that the error was caused by the microservice and to take corrective action (e.g., if needed) to mitigate the error and/or reduce the likelihood of similar errors occurring in the future.

As shown by reference number 150, the test system may detect an outage associated with a test workflow based on the result information. For example, based on the test system detecting the error (e.g., based on the test system generating an incident for the test workflow), the test system may determine whether any other errors (e.g., any other incidents) have been detected within a time window. The time window may be a configurable amount of time. In some implementations, the time window may be indicated by a user configuration for the test workflow stored in the one or more databases. In some implementations, the time window may be based on the periodic schedule associated with triggering the test workflow (e.g., as described elsewhere herein). For example, the time window may be a factor of a period between invocations of the test workflow as indicated by the periodic schedule.

In some implementations, the test system may detect the outage based on a quantity of consecutive invocations of the test workflow having a detected error and/or incident. For example, if the quantity of consecutive invocations of the test workflow having a detected error and/or incident satisfies an outage threshold, then the test system may determine that there is an outage associated with the test workflow. In some implementations, if the test system determines that the quantity satisfies the outage threshold, the test system may determine if maintenance information for the test workflow indicates that there is a planned outage for one or more microservices associated with the test workflow. The maintenance information may indicate a time period during which the one or more microservices are planned to be offline or otherwise unavailable. If the maintenance information indicates that there is a planned outage (e.g., for maintenance and/or other reasons) for a period of time during which at least one of the errors and/or incidents is detected, then the test system may determine that there is not an outage (e.g., an unplanned outage) for the test workflow (e.g., as the detected streak of errors and/or incidents are caused by the planned outage). If the maintenance information indicates that there is not a planned outage for the period of time during which at least one of the errors and/or incidents is detected, then the test system may determine that there is an outage (e.g., an unplanned outage) for the test workflow.

As shown by reference number 155, the test system may transmit, to one or more subscriber devices, outage information (e.g., one or more outage messages) for a detected outage. The outage information may indicate the test workflow, the one or more errors detected for the test workflow, and/or any determined causes of the detected error(s), among other examples. For example, the outage information may be a notification of the detected outage and the error(s) that were detected. One or more accounts (e.g., outage subscriber accounts) may subscribe to receive notifications of outages for the test workflow. In such examples, the test system may transmit the outage information (e.g., the one or more outage messages) to addresses (e.g., to one or more subscriber devices and/or accounts) based on detecting the outage. This enables one or more users to quickly identify that the outage has occurred and to take corrective action (e.g., if needed) to mitigate the outage and/or reduce the likelihood of similar outages occurring in the future.

For example, by the test system detecting the outage, the test system can detect when certain functionality of the microservice system (e.g., for which the test workflow is configured to test) is not functioning properly. This enables the test system to detect outages on a more granular level (e.g., on a functionality level) for the microservice system. Further, this enables the test system to provide subscribers of detected outages with more granular information (e.g., which function(s) are not working properly and/or determined causes of detected errors), thereby enabling improved mitigation of the outages.

As shown in FIG. 1D, and by reference number 160, the test system may generate report information for the one or more test workflows. The report information may include one or more reports (e.g., error reports) for the one or more test workflows. The one or more reports may indicate the results of one or more invocations of the one or more test workflows over time (e.g., indicating whether the one or more invocations were successful). For example, a report may indicate a success rate for invocations of a given test workflow over time. Additionally, a report may indicate performance information for one or more microservices associated with a given test workflow. For example, as described herein, the test system may determine a cause of a detected error for a given test workflow. The cause may be one or more microservices. Therefore, the test system can generate the report information to include performance information for a microservice where the performance information is indicative of whether and/or how often the microservice is a cause of an error for the given test workflow.

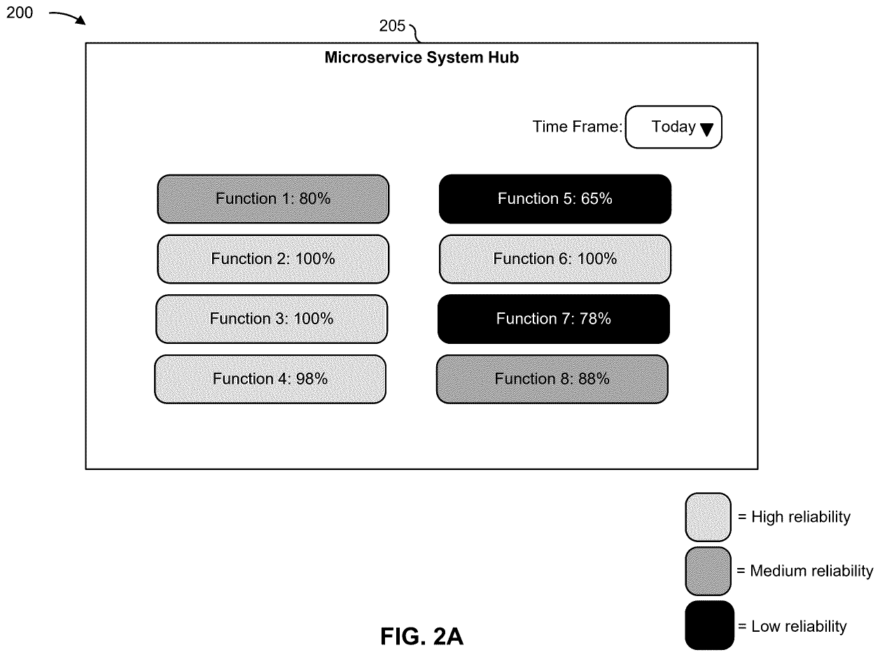

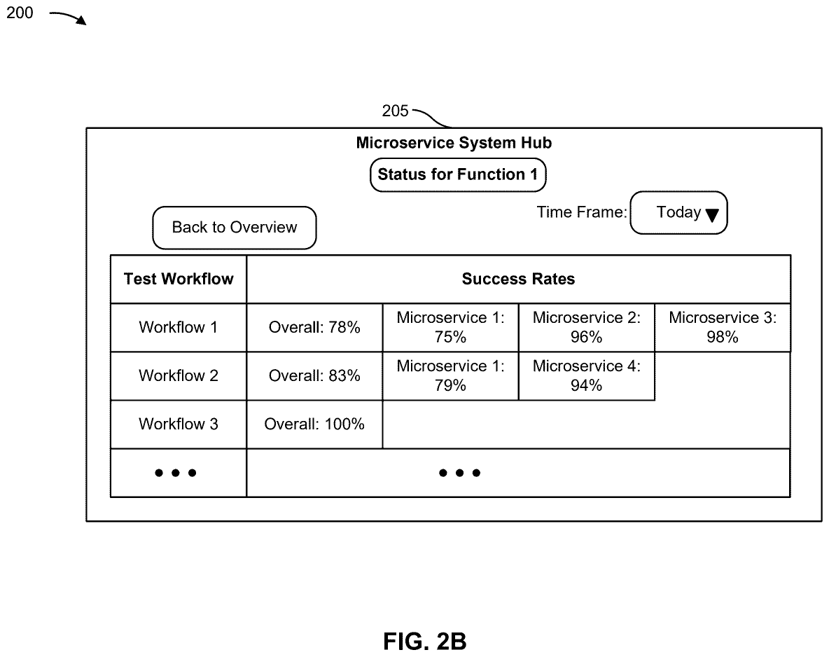

As shown by reference number 165, the test system may transmit, and the client device may receive, the report information. As shown by reference number 170, the client device may display the report information. For example, the report information may include display information for a user interface (e.g., as depicted and described in more detail in connection with FIGS. 2A and 2B). The client device may use the display information to render one or more elements of the user interface. The client device may display one or more reports indicated by the report information via the user interface. This enables a user to view and/or interact with the one or more reports. The one or more reports may provide a more granular view of detected errors and/or outages for the microservice system over time by indicating performance information for given test workflows (e.g., indicating a performance of different functions of the microservice system) and/or for particular microservices (e.g., enabling a user to identify which microservices are not performing as expected over time).

As indicated above, FIGS. 1A-1D are provided as an example. Other examples may differ from what is described with regard to FIGS. 1A-1D.

FIGS. 2A and 2B are diagrams of an example 200 associated with a user interface 205 for microservice error detection. The user interface 205 may be displayed by a client device, such as described in connection with FIG. 1D and reference number 170.

As shown in FIG. 2A, the user interface 205 may display one or more reports for respective functions of a microservice system. As described elsewhere herein, a function may be associated with a test workflow. For example, the test workflow may be configured or designed to test the function. A report for a function may indicate performance information for that function (e.g., based on result information for one or more invocations of one or more test workflows associated with the function). As shown in FIG. 2A, the performance information may indicate a reliability level of a given function (e.g., high reliability, medium reliability, and/or low reliability). The reliability level may be based on incident, error, and/or outage statistics for the test workflow. For example, the result information for a given test workflow may indicate a success rate for the one or more test workflows (e.g., indicating a percentage of invocations of the test workflow(s) that were performed successfully with no detected errors).

As shown in FIG. 2A, the report(s) may be presented based on a selected time frame (shown in FIG. 2A as “Today”). For example, the report(s) may indicate the performance level of the one or more functions over the selected time frame.

As shown in FIG. 2B, the user interface 205 may display report information for a respective function and/or subsystem of the microservice system. For example, a function and/or subsystem may be associated with one or more test workflows (shown as three test workflows in FIG. 2B as an example). The report information for the function may indicate performance information for respective test workflows. For example, the performance information may include an overall success rate for a given test workflow (e.g., indicating a percentage of invocations of the test workflow that were performed successfully with no detected errors over the selected time frame). Additionally, the performance information may include success rates for respective microservices of one or more microservices used to perform a given test workflow.

For example, as described elsewhere herein, a test system may determine a cause (e.g., a root cause) of detected errors for one or more test workflows. The cause may be one or more microservices. This enables the test system to generate a report that indicates performance information for respective microservices of the microservice system. As shown in FIG. 2B, a success rate for a given microservice may indicate a percentage of invocations of the test workflow for which the microservice was not the cause of a detected error. The success rates are provided as an example. In other examples, the performance information may be displayed as failure rates, among other examples, based on the errors, outages, and/or causes detected or determined by the test system, as described in more detail elsewhere herein.

As indicated above, FIGS. 2A and 2B are provided as an example. Other examples may differ from what is described with regard to FIGS. 2A and 2B.

FIG. 3 is a diagram of an example environment 300 in which systems and/or methods described herein may be implemented. As shown in FIG. 3, environment 300 may include a test system 310, a microservice system 320, one or more databases 330, one or more subscriber devices 340, a client device 350, and a network 360. Devices of environment 300 may interconnect via wired connections, wireless connections, or a combination of wired and wireless connections.

The test system 310 may include one or more devices capable of receiving, generating, storing, processing, providing, and/or routing information associated with microservice error detection, as described elsewhere herein. The test system 310 may include a communication device and/or a computing device. For example, the test system 310 may include a server, such as an application server, a client server, a web server, a database server, a host server, a proxy server, a virtual server (e.g., executing on computing hardware), or a server in a cloud computing system. In some implementations, the test system 310 may include computing hardware used in a cloud computing environment, such as one or more serverless components (e.g., one or more serverless functions), among other examples.

The microservice system 320 may include one or more devices capable of receiving, generating, storing, processing, providing, and/or routing information associated with microservice error detection, as described elsewhere herein. The microservice system 320 may include a communication device and/or a computing device. For example, the microservice system 320 may include a server, such as an application server, a client server, a web server, a database server, a host server, a proxy server, a virtual server (e.g., executing on computing hardware), or a server in a cloud computing system. In some implementations, the microservice system 320 may include computing hardware used in a cloud computing environment, such as one or more serverless components (e.g., one or more serverless functions), among other examples.

The microservice system 320 may include multiple microservices. A microservice may include a communication device and/or a computing device. For example, the microservice may include a server, such as an application server, a client server, a web server, a database server, a host server, a proxy server, a virtual server (e.g., executing on computing hardware), a server in a cloud computing system, and/or a serverless component in a cloud computing system, among other examples.

The database 330 may include one or more devices capable of receiving, generating, storing, processing, and/or providing information associated with microservice error detection, as described elsewhere herein. The database 330 may include a communication device and/or a computing device. For example, the database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the one or more databases 330 may store incident information, error information, outage information, and/or user configuration information, among other examples, as described elsewhere herein.

The subscriber device 340 may include one or more devices capable of receiving, generating, storing, processing, and/or providing information associated with microservice error detection, as described elsewhere herein. The subscriber device 340 may include a communication device and/or a computing device. For example, the subscriber device 340 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The client device 350 may include one or more devices capable of receiving, generating, storing, processing, and/or providing information associated with microservice error detection, as described elsewhere herein. The client device 350 may include a communication device and/or a computing device. For example, the client device 350 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 360 may include one or more wired and/or wireless networks. For example, the network 360 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 360 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with microservice error detection. The device 400 may correspond to the test system 310, the microservice system 320, a database 330, a subscriber device 340, and/or the client device 350. In some implementations, the test system 310, the microservice system 320, a database 330, a subscriber device 340, and/or the client device 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

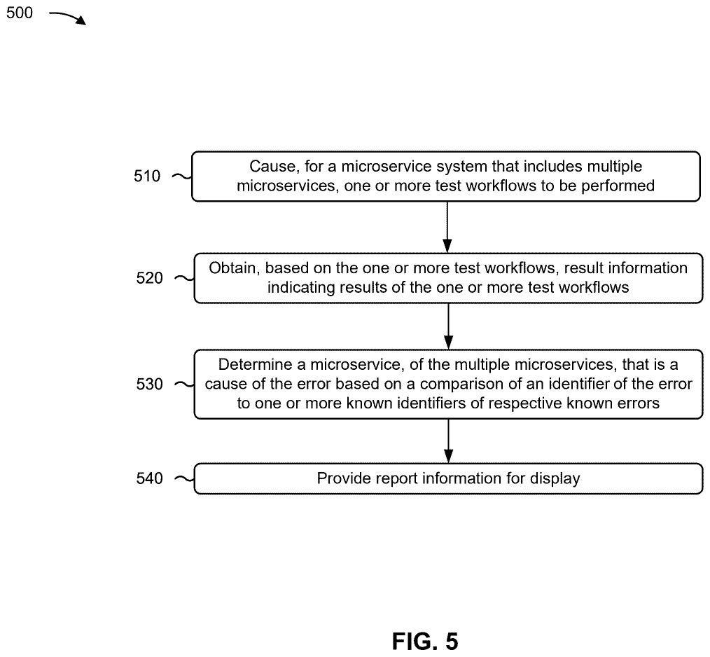

FIG. 5 is a flowchart of an example process 500 associated with microservice error detection. In some implementations, one or more process blocks of FIG. 5 may be performed by the test system 310. In some implementations, one or more process blocks of FIG. 5 may be performed by another device or a group of devices separate from or including the test system 310, such as the microservice system 320, the database(s) 330, the subscriber device(s) 340, and/or the client device 350. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include causing, for a microservice system that includes multiple microservices, one or more test workflows to be performed (block 510). For example, the test system 310 (e.g., using processor 420 and/or memory 430) may cause, for a microservice system that includes multiple microservices, one or more test workflows to be performed, as described above in connection with reference number 105 of FIG. 1A. As an example, the one or more test workflows may be configured to test respective functions of the microservice system. The microservice system (e.g., the microservice system 320) may perform the one or more test workflows via one or more microservices of the microservice system.

As further shown in FIG. 5, process 500 may include obtaining, based on the one or more test workflows, result information indicating results of the one or more test workflows (block 520). For example, the test system 310 (e.g., using processor 420 and/or memory 430) may obtain, based on the one or more test workflows, result information indicating results of the one or more test workflows, as described above in connection with reference number 115 of FIG. 1A. As an example, the result information may indicate whether the one or more test workflows (e.g., one or more invocations of the one or more test workflows) were successfully performed. For example, the result information may indicate error information for an error associated with at least one test workflow of the one or more test workflows.

As further shown in FIG. 5, process 500 may include determining a microservice, of the multiple microservices, that is a cause of the error based on a comparison of an identifier of the error to one or more known identifiers of respective known errors (block 530). For example, the test system 310 (e.g., using processor 420 and/or memory 430) may determine a microservice, of the multiple microservices, that is a cause of the error based on a comparison of an identifier of the error to one or more known identifiers of respective known errors, as described above in connection with reference number 135 of FIG. 1B. As an example, the identifier of the error may be based on the error information. For example, the test system 310 may generate the identifier based on the error information for the error. In some implementations, the identifier may be a hash or other sequence that is based on the error information. The known identifier(s) may be hashes or sequences that are based on known errors with known causes. The comparison may indicate that the error matches and/or is similar to a known error. The known cause of the known error may be the microservice.

As further shown in FIG. 5, process 500 may include providing report information for display, wherein the report information indicates the error and that the microservice is the cause of the error (block 540). For example, the test system 310 (e.g., using processor 420 and/or memory 430) may provide report information for display, as described above in connection with reference number 165 of FIG. 1D. As an example, the report information may indicate the error and that the microservice is the cause of the error. An example of a user interface displaying the report information is shown in FIGS. 2A and 2B.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D, 2A, and 2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A test system for microservice error detection, the test system comprising:
one or more memories; and
one or more processors, communicatively coupled to the one or more memories, configured to:
cause, for a microservice system that includes multiple microservices, one or more test workflows to be performed, wherein the one or more test workflows are configured to test one or more functions of the microservice system;
obtain, based on the one or more test workflows, result information indicating results of the one or more test workflows;
detect, based on the result information, an error associated with at least one test workflow of the one or more test workflows;
determine a cause of the error based on a comparison of the error to one or more known errors; and
provide, for display, report information that indicates the error and the cause.

2. The test system of claim 1, wherein the comparison indicates that a similarity level between the error and a known error, of the one or more known errors, satisfies a similarity threshold, wherein the known error has a known cause of a microservice of the multiple microservices, and wherein the cause is the microservice based on the known cause being the microservice.

3. The test system of claim 1, wherein the cause is an unassigned cause based on the comparison indicating that:
a first similarity level between the error and the one or more known errors does not satisfy a similarity threshold, or
a second similarity level between the error and a known error, of the one or more known errors, satisfies the similarity threshold, wherein the known error has the unassigned cause.

4. The test system of claim 1, wherein the one or more processors, to determine the cause, are configured to:
determine one or more similarity levels between an identifier of the error and one or more known identifiers of respective known errors of the one or more known errors; and
determine that a similarity level, of the one or more similarity levels, satisfies a similarity threshold, wherein the similarity level is associated with a known error of the one or more known errors; and
determine the cause based on a known cause of the known error.

5. The test system of claim 4, wherein the identifier is a string identifying the error.

6. The test system of claim 4, wherein the result information includes an error message for the error, and wherein the identifier is a hash of an error object that is based on the error message.

7. The test system of claim 4, wherein the one or more processors, to determine the one or more similarity levels, are configured to:
perform one or more substring matching operations using the identifier and the one or more known identifiers to determine the one or more similarity levels.

8. The test system of claim 1, wherein the one or more processors, to detect the error, are configured to:
detect multiple errors, including the error, for the at least one test workflow during a time window; and
wherein the one or more processors are further configured to:
detect an outage for the at least one test workflow based on a quantity of the multiple errors satisfying an outage threshold.

9. The test system of claim 8, wherein the one or more processors are further configured to:
transmit, to one or more outage subscriber accounts for the at least one test workflow, one or more outage messages indicating the outage, the at least one test workflow, and the multiple errors.

10. The test system of claim 1, wherein the cause is a microservice of the multiple microservices, and wherein the one or more processors are further configured to:
transmit, to one or more cause subscriber accounts for the microservice, a cause message indicating the error and that the microservice is the cause of the error.

11. A method for microservice error detection, comprising:
causing, by a test system and for a microservice system that includes multiple microservices, one or more test workflows to be performed;
obtaining, by the test system and based on the one or more test workflows, result information indicating results of the one or more test workflows, wherein the result information indicates error information for an error associated with at least one test workflow of the one or more test workflows;
determining, by the test system, a microservice, of the multiple microservices, that is a cause of the error based on a comparison of an identifier of the error to one or more known identifiers of respective known errors, wherein the identifier of the error is based on the error information; and
providing, by the test system, report information for display, wherein the report information indicates the error and that the microservice is the cause of the error.

12. The method of claim 11, wherein the comparison indicates that a similarity level between the identifier and a known identifier, of the one or more known identifiers, satisfies a similarity threshold, wherein the known identifier is associated with a known error, wherein the known error has a known cause of the microservice, and wherein the cause is the microservice based on the known cause being the microservice.

13. The method of claim 11, wherein the identifier is a hash of the error information.

14. The method of claim 11, wherein determining the microservice that is the cause of the error comprises:
performing one or more matching operations using the identifier and the one or more known identifiers;
determine, based on the one or more matching operations, that the error matches a known error; and
determine that the microservice is the cause of the error based on the known error having a known cause of the microservice.

15. The method of claim 14, wherein the one or more matching operations include at least one of:
a substring matching operation, or
a fuzzy matching operation.

16. The method of claim 11, wherein the report information includes error reports for respective test workflows of the one or more test workflows.

17. The method of claim 11, wherein the one or more test workflows are configured to test respective functions of the microservice system.

18. A non-transitory computer-readable medium storing a set of instructions, the set of instructions comprising:
one or more instructions that, when executed by one or more processors of a test system, cause the test system to:
cause, for a microservice system that includes multiple microservices, one or more test workflows to be performed;
obtain, based on the one or more test workflows, result information indicating results of the one or more test workflows, wherein the result information indicates error information for an error associated with at least one test workflow of the one or more test workflows;
determine a microservice, of the multiple microservices, that is a cause of the error based on a comparison of an identifier of the error to one or more known identifiers of respective known errors, wherein the identifier of the error is based on the error information; and
provide report information for display, wherein the report information indicates the error and that the microservice is the cause of the error.

19. The non-transitory computer-readable medium of claim 18, wherein the comparison indicates that a similarity level between the identifier and a known identifier, of the one or more known identifiers, satisfies a similarity threshold, wherein the known identifier is associated with a known error, wherein the known error has a known cause of the microservice, and wherein the cause is the microservice based on the known cause being the microservice.

20. The non-transitory computer-readable medium of claim 18, wherein the identifier is a hash of the error information.
